(19) United States
(12) Patent Application Publication
(10) Pub. No.: US 2011/0260567 A1
(43) Pub. Date: Oct. 27, 2011

(54) MOTOR WITHOUT ARMATURE COIL

(76) Inventor: CHUAN-SHENG CHEN, Taipei (TW)

(21) Appl. No.: 12/822,189

(22) Filed: Jun. 24, 2010

(30) Foreign Application Priority Data
Apr. 26, 2010 (TW) 099113006

(51) Int. Cl. H02K 21/24

(52) U.S. Cl. 310/156.35; 310/156.36

(57) ABSTRACT

The motor contains a rotary disc, a number of magnets, a first stationary disc, a second stationary disc, a number of electromagnets, a casing member, and an electromagnetic circuit connected to the electromagnets. The magnets are uniformly distributed and embedded inside the rotary disc. The electromagnets are fixedly positioned on inner sides of the stationary discs facing the magnets. An axle runs through the rotary disc and is supported by the casing member by bearings. When electricity is applied, electrical current flows to an electromagnet, and a magnetic pole is thereby produced and interaction with the magnetic field of the magnet is activated. The rotary disc is turned by the magnetic expel or attraction between the electromagnets and the magnets of the rotary disc. As the rotary disc is turned, the axle is spun as well to deliver power.

### (A) TECHNICAL FIELD OF THE INVENTION

The present invention generally relates to electrical motors, and more particular to a motor without armature coils.

### (B) DESCRIPTION OF THE PRIOR ART

A conventional motor usually has yokes wound by enameled wires as basic components, and the motor requires magnets and carbon bushes to achieve rotation and output of torque. A major drawback of the conventional motor is its significant power consumption, especially when the motor is started. In addition, the conventional motor's use of yokes for winding and cast iron as casing lead to a bulky size and a heavy weight. The maintenance and repair are less convenient. Further more, the conventional motor requires magnetic polarities arranged alternatively and as such is often limited to a cylindrical shape. The conventional motor also cannot function as an idle speed control motor and its application is therefore limited.

### SUMMARY OF THE INVENTION

Therefore, a novel motor is provided herein to obviate the foregoing shortcomings of the prior art. The motor contains a rotary disc, a number of magnets, a first stationary disc, a second stationary disc, a number of electromagnets, a casing member, and an electromagnetic circuit connected to the electromagnets. The rotary disc, and the first and second stationary discs are made of an insulating material such as plastics. The magnets are uniformly distributed and embedded inside the rotary disc when the rotary disc is formed. The electromagnets are fixedly positioned on inner sides of the stationary discs facing the magnets. An axle runs through the rotary disc and is supported by the casing member by bearings. The electromagnetic circuit is connected to each electromagnet through an electromagnetic contact. When electricity is applied under the control of an electromagnetic switch's PNP contact, electrical current flows through each electromagnetic contact to an electromagnet, and a magnetic pole is thereby produced and interaction with the magnetic field of the magnet is activated. The rotary disc is turned by the magnetic expel or attraction between the electromagnets and the magnets of the rotary disc. As the rotary disc is turned, the axle is spun as well to deliver power. Additional pairs of rotary discs and second stationary discs could be configured and arranged in sequence so as to deliver more power required by industrial applications. The present invention does not required enameled wires winding around yokes, and does not require heavy cast iron as casing. Therefore a motor of the present invention is structurally simple, light-weight, and could have a small form factor to be flexibly applied to various object or device requiring motor power.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a motor according to an embodiment of the present invention where its major components are separated for better understanding.

FIG. 2 is a perspective diagram showing the motor of FIG. 1 under a general configuration.

FIG. 3 is a cross-sectional diagram showing the motor of FIG. 1.

FIG. 4 is a schematic diagram showing the electromagnetic circuit of the motor of FIG. 1.

FIG. 5 is a perspective diagram showing a motor according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

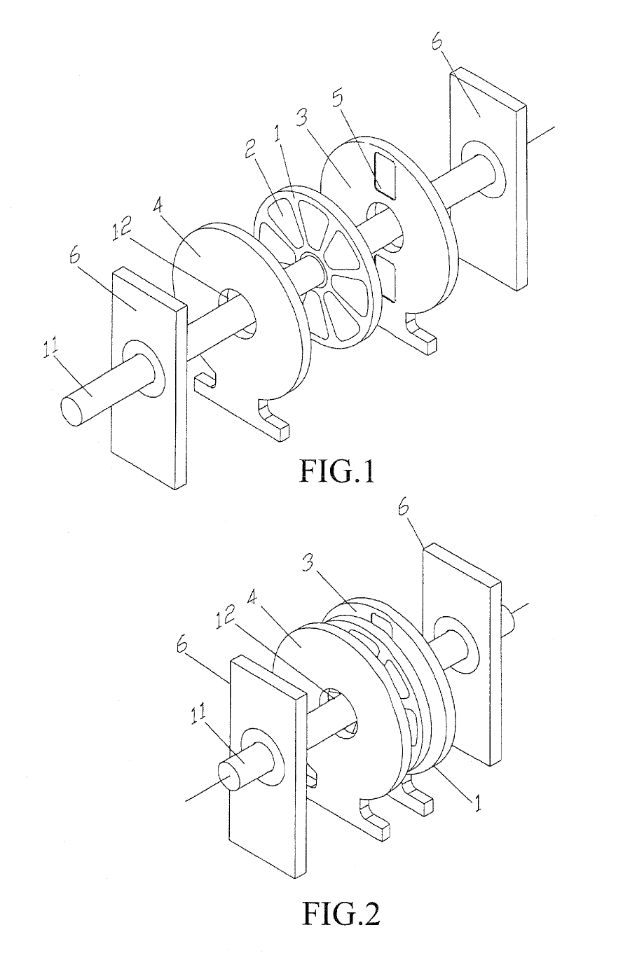

As shown in FIGS. 1 and 2, a motor without armature coil according to an embodiment of the present invention contains a rotary disc 1, a number of magnets 2, a first stationary disc 3, a second stationary disc 4, a number of induction magnets or electromagnets, a casing member 6 (only partially shown), and an electromagnetic circuit 7 connected to the electromagnets 5. The rotary disc 1, and the first and second stationary discs 3 and 4 are formed by plastic injection molding, or integrally formed by some insulating material.

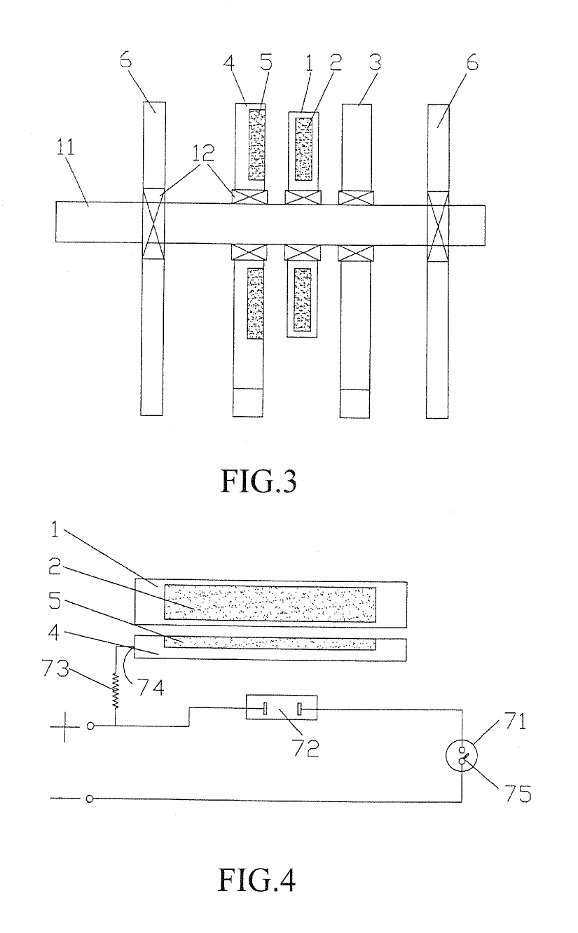

As shown in FIG. 3, the rotary disc 1 has a transmission axle 11 and the magnets 2 are uniformly distributed and embedded inside the rotary disc 1 when the rotary disc 1 is formed. The axle 11 is supported by the casing member 6 by bearings 12. The stationary discs 3 and 4, on the other hand, are fixedly positioned to the casing of the motor or a base inside the casing. The electromagnets 5 are fixedly positioned on inner sides of the stationary discs 3 and 4 facing the magnets 2.

As shown in FIG. 4, the electromagnetic circuit 7 is composed of an electromagnetic switch 71 having a PNP contact 75, a capacitor 72, a resistor 73. The electromagnetic circuit 7 is connected to each electromagnet 5 through an electromagnetic contact 74. When electricity is applied, electrical current flows through each pre-configured electromagnetic contact 74 by the control of the PNP contact 75 to an electromagnet 5. A magnetic pole is thereby produced and interaction with the magnetic field is activated. When the electromagnetic switch 71 disrupts the electrical current, the attraction or expel of magnetic interaction is terminated.

The rotary disc 1 is turned by the magnetic expel or attraction between the electromagnets 5 and the magnets 2 of the rotary disc 1. As the rotary disc 1 is turned, the axle 11 is spun as well to deliver power.

The foregoing PNP contact 75 could also be replaced with a platinum contact.

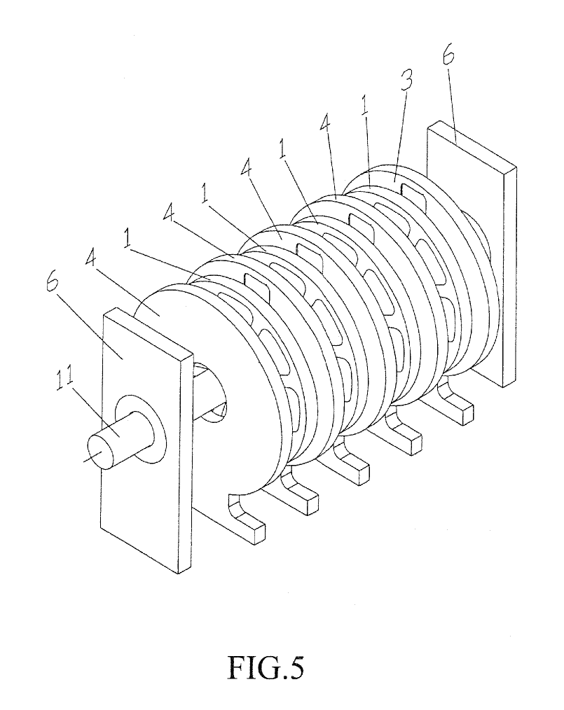

As shown in FIG. 5, in an alternative embodiment of the present invention, a rotary disc 1 and a second stationary disc 4 could be paired and additional pairs of rotary discs 1 and second stationary discs 4 could be configured and arranged in sequence as illustrated. In this embodiment, the electromagnets 5 could be configured only on a side of each second stationary disc 4, instead of on two sides. This embodiment is able to deliver more power and therefore is appropriate for industrial applications.

The present invention, as described, does not required enameled wires winding around yokes, and does not require heavy cast iron as casing. Therefore a motor of the present invention is light-weight, and could have a limited form factor to be flexibly applied to various object or device requiring motor power. For example, a motor of the present invention could be conveniently installed on a bicycle so as to make an electric bicycle. There is no complicated configuration and there is no power transmission problem. In addition, when the motor is started, there is no particularly significant power consumption.

Due to its small form factor, other exemplary applications of the present invention include the heat-dissipating fans for computers, air conditioners, automobiles. On the other hand, due to its power saving, the motor could also be applied to various electric vehicles, such as bicycles, motorcycles, and automobiles. Further more, motors of the present invention could be flexibly cascaded to produce higher output power and therefore could be deployed for various industrial applications.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A motor, comprising:
a rotary disc made of an insulating material;
a plurality of magnets distributed and embedded inside said rotary disc;
a first stationary disc and a second stationary disc, both made of an insulating material, sandwiching said rotary disc;
a plurality of electromagnets on an inner side of said first and second stationary discs facing said rotary disc;
an axle running through said rotary disc;
a casing member supporting said axle by bearings; and
an electromagnetic circuit connected to said electromagnets, said electromagnetic circuit having an electromagnetic switch where electricity is applied to said electromagnets through a PNP contact of said electromagnetic switch;
wherein said rotary disc, and therefore said axle, is turned by magnetic expel or attraction between said electromagnets as electricity is applied through said electromagnetic circuit and said magnets of said rotary disc.

2. The motor according to claim 1, wherein at least an additional pair of a rotary disc and a second stationary disc are configured to provide additional power.

3. The motor according to claim 1, wherein said electromagnetic circuit comprises said electromagnetic switch having said PNP contact, a capacitor, and a resistor; and said PNP contact controls the application of electricity to said electromagnets.

4. The motor according to claim 1, wherein said PNP contact is replaced with a platinum contact.
